(19) United States
(12) Patent Application Publication
(10) Pub. No.: US 2009/0313893 A1
(43) Pub. Date: Dec. 24, 2009

(54) METHOD AND APPARATUS FOR IMPROVING VITALITY OF A POTTED PLANT

(76) Inventor: Jonothon M.W. McIntyre, Palmdale, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/141,632

(22) Filed: Jun. 18, 2008

(51) Int. Cl. A01G 29/00; A01G 25/00

(52) U.S. Cl. 47/79; 47/48.5

(57) ABSTRACT

A hollow elongated cylinder having a plurality of slots and holes through the side thereof is inserted into the soil of a potted plant. The cylinder is inserted adjacent to the plant stem and down into the soil so that it is proximate to the roots of the potted plant. Water and/or fertilizer poured into the hollow cylinder are introduced directly to the roots of the potted plant. The roots will naturally grow through the apertures in the cylinder to more directly access the fertilizer and/or water. The cylinder can be transferred with the plant and soil to a new pot as the plant grows, with additional cylinders inserted into the new soil.

### BACKGROUND OF THE INVENTION

Since colonial times and before, people have been searching for better and more efficient containers for plants, particularly during transportation. Initially, plants were placed in wooden containers as wood was readily available and easy to work with. However, wood containers presented a problem, particularly when one needed to transport potted plants in a damp environment, i.e., across the Atlantic Ocean. The damp air would rot the wood and present hazards for those transporting the plants.

Eventually it was discovered that terra cotta clay pots, previously used to store and ship olive oil, were better for shipping plants than wood containers. The terra cotta clay was more durable than the wood and allowed water to slowly leach through the container. One could wrap a terra cotta pot in wet rags, including rags wet with salt water, and the clay would allow the water to leach through while preventing the salt from doing the same. The passage of water through the clay material helped to equalize the temperature in the roots to be similar to ambient temperature. The equalized temperature reduced the growth of bacteria, which could cause premature death of the plant.

As times changed and new materials and methods of manufacturing developed, people moved away from terra cotta pots. More common materials for plant pots now include plastic and/or fired/glazed ceramics. The ceramic materials are too dense to allow water to leach through. The plastic, in addition to not allowing water to pass through, retain heat. This retained heat contributes to the growth of bacteria in the rootball which leads to the premature death of plants.

In order to overcome the failure of ceramic and plastic pots to allow water to pass through the material, manufacturers began placing holes in the bottoms of the pots. These holes allowed water to drain from the pot so that the plant would not drown. However, these holes let out the water faster than was necessary and the plants ended up not getting enough water or having to be watered more frequently.

Accordingly, there is a need to improve the performance of ceramic and plastic pots that contain domestic plants. In addition, there is a need to improve the handling of water, moisture and heat retention in potted plants. The following invention satisfies these needs and provides other related advantages.

### SUMMARY OF THE INVENTION

The present invention is directed to an apparatus for improving the vitality of a potted plant. The invention comprises an elongated hollow cylinder for inserting into the soil of a potted plant. The cylinder has open top and bottom ends and a plurality of apertures through the side thereof. The cylinder is preferably made from terra cotta clay, but other materials such as PVC plastic or similar polymers will work.

The apertures comprise elongated slots or holes to allow the passage of water out into the soil in addition to the normal leaching mechanism. The elongated slots or holes also permit the passage of roots and/or soil into the cylinder. The cylinder also includes a plurality of circumferential grooves along its length.

The apparatus further comprises a plug for closing the bottom end of the cylinder, the plug having a pointed end. This plug is preferably comprised of cork, plastic or an organic material, i.e., compressed granular fertilizer. The plug may also include a nitrogen plant fertilizer.

The cylinder is preferably inserted into soil surrounding a plant potted in a container. The invention is particularly intended to be used with plant containers made from ceramic or plastic, but may be used with any type of plant container including terra cotta clay or wood.

The inventive method for improving vitality of a domestic plant comprises the steps of planting the domestic plant in a container having soil and placing an elongated hollow cylinder into the soil between the plant and a wall of the container. The cylinder has open top and bottom ends and a plurality of apertures through the side of the cylinder. The method further includes the step of putting water or fertilizer into the open top of the cylinder.

When placing the cylinder into soil, the cylinder should be pushed down into the soil such that the bottom end of the cylinder is proximate to the bottom of the container. In addition, a portion of the apertures through the side of the cylinder should be proximate to the roots of the domestic plant such that the roots grow into the apertures. The length of the cylinder may be adjusted by breaking the cylinder at one of a plurality of circumferential grooves along the length of the cylinder.

The method may further comprise the step of transferring the potted domestic plant from the container to a second container. The transfer of the plant involves removing the plant, soil and cylinder from the first container as a single unit. The plant, soil and cylinder are then repotted into a second larger container using additional soil. A second elongated hollow cylinder is then placed in the additional soil between the plant and the wall of the second container.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of the apparatus of the present invention;

FIG. 2 is an exploded close-up view of the bottom end of the apparatus of the present invention including the plug;

FIG. 3 is a close-up view of the bottom end of the apparatus of the present invention showing the plug inserted in the apparatus;

FIG. 4 is a cross-section of the apparatus taken along line 4-4 of FIG. 3;

FIG. 5 is another view of the apparatus of FIG. 4 illustrating the growth of plant roots through the apertures;

FIG. 6 is an illustration of a potted plant including an apparatus of the present invention;

FIG. 7 is a cross-section of a potted plant taken along line 7-7 of FIG. 6; and

FIG. 8 illustrates in cross-section the repotting of a plant in a larger pot.

### DETAILED DESCRIPTION OF THE PREFERRED EMBODIMENT

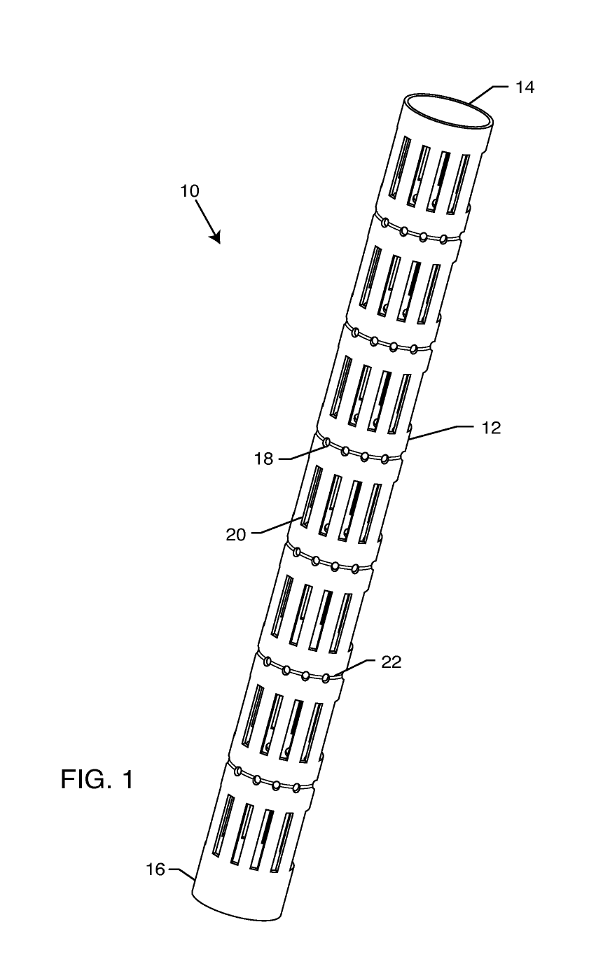

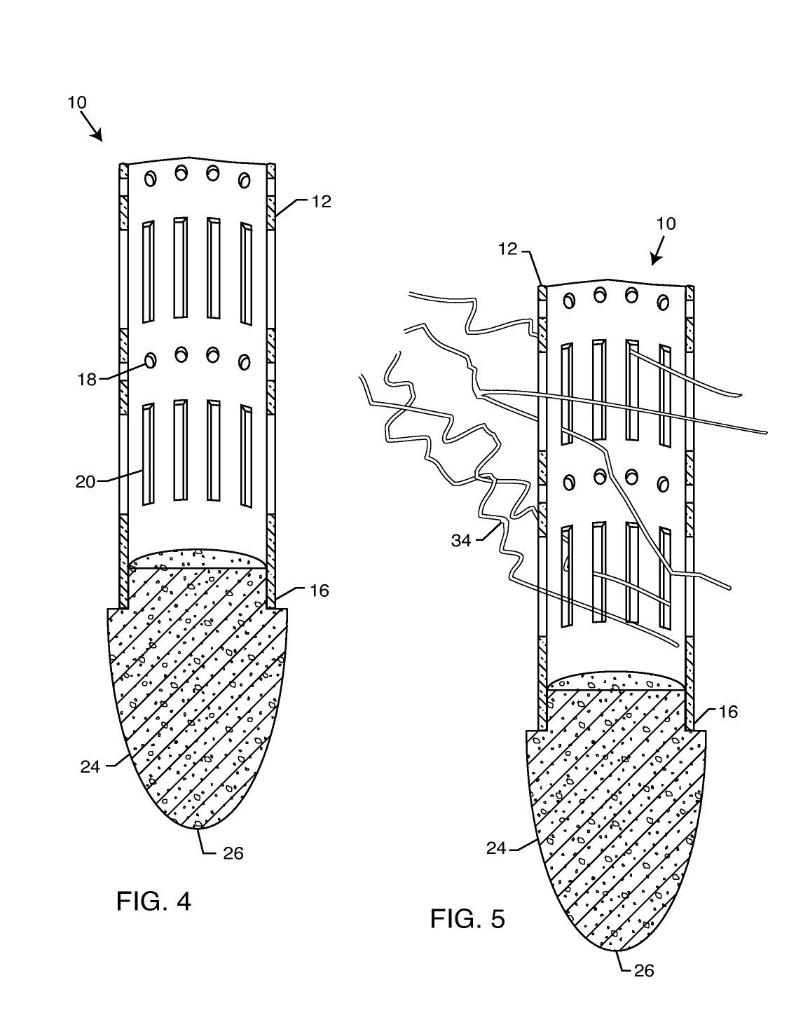

As shown in the exemplary drawings, for purposes of illustration, the present invention is concerned with a method and apparatus for improving the vitality of potted plants. As shown in FIGS. 1-4, the apparatus, generally referred to by reference numeral 10, is comprised mainly of an elongated hollow cylinder 12. The cylinder 12 includes open top 14 and bottom 16 ends. The wall of the cylinder 12 includes a plurality of apertures in the form of holes 18 and/or slots 20.

The cylinder 12 is preferably made from terra cotta earthen clay with a consistency of between sixteen percent and twenty percent porosity. The stated range of porosity provides sufficient hardness and durability of the terra cotta clay while maximizing the saturation and evaporation benefits provided by the apparatus 10. In the preferred embodiment, the terra cotta earthen clay has a porosity of not less than eighteen percent. In alternate embodiments, the cylinder 12 may also be made from a hard plastic material, i.e., PVC, or similar material with sufficient hardness and durability as described. The lack of porosity of PVC or similar material is overcome by the inclusion of the holes 18 and slots 20 in the side thereof.

For an average size potted plant, the cylinder 12 preferably has a length of between twelve to sixteen inches, with an inner diameter of about seven eights of an inch and a wall thickness of between two eighths and three eighths of an inch. A person skilled in the art will realize that the dimensions of length, inner diameter and wall thickness are not critical to the functionality of the apparatus 10 and that other dimensions will function in a similar manner. For example, a larger potted plant such as a tree would require an apparatus 10 that is significantly longer and has a greater diameter than an apparatus 10 required for an average sized potted plant. In addition, the size and frequency of the holes 18 and/or slots 20 will be varied depending upon the size of the apparatus 10 and the size of potted plant with which it is to be used. A larger plant, like a tree, will have larger roots and will require larger holes 18 and/or slots 20.

The cylinder 12 may include score marks 22 around its perimeter at various points along its length. The score marks 22 allow a user to break the cylinder 12 at a point to adjust the length as appropriate for the size of the potted plant. In this way, the apparatus 10 may be manufactured at a few different lengths and sized as needed at the time of insertion.

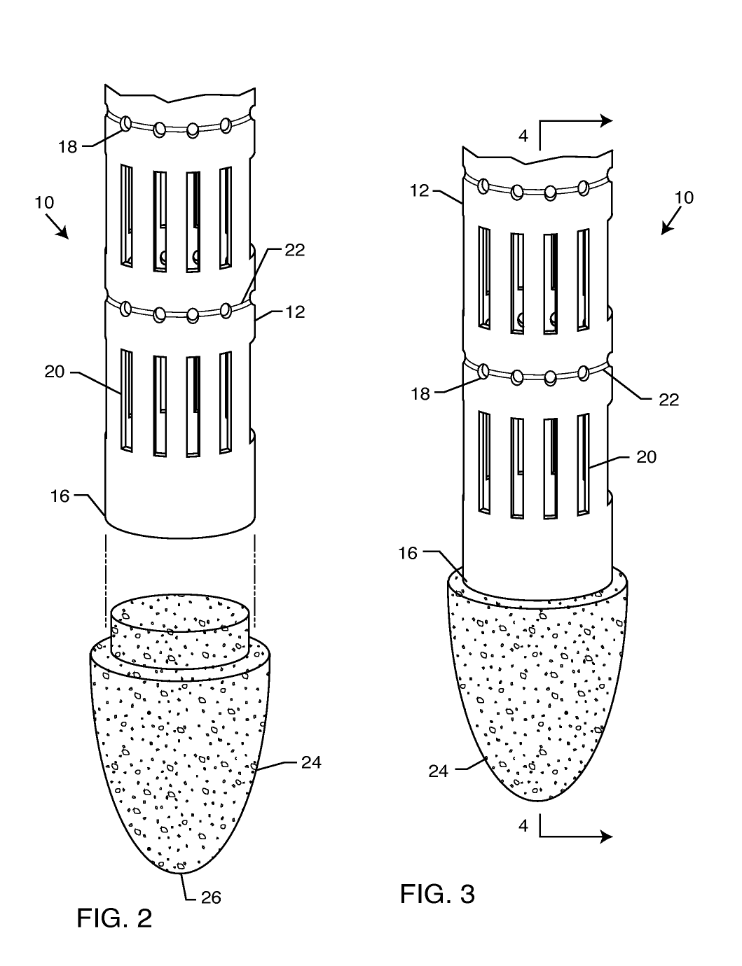

As illustrated in FIGS. 2, 3 and 4, the apparatus 10 may include a plug 24 inserted in the bottom end 16 of the cylinder 12. This plug 24 comprises a compressed granular particulate matter which is formed with a pointed or conical tip 26. The particulate or granular matter in the plug 24 may include a fertilizing material such as nitrogen, nitrite or vitamin B1. This fertilizer material will leach from the plug 24 into the surrounding soil to provide additional nutritional assistance to the potted plant. The shaped tip 26 is configured to allow for easy insertion of the apparatus 10 into a potted plant as described below.

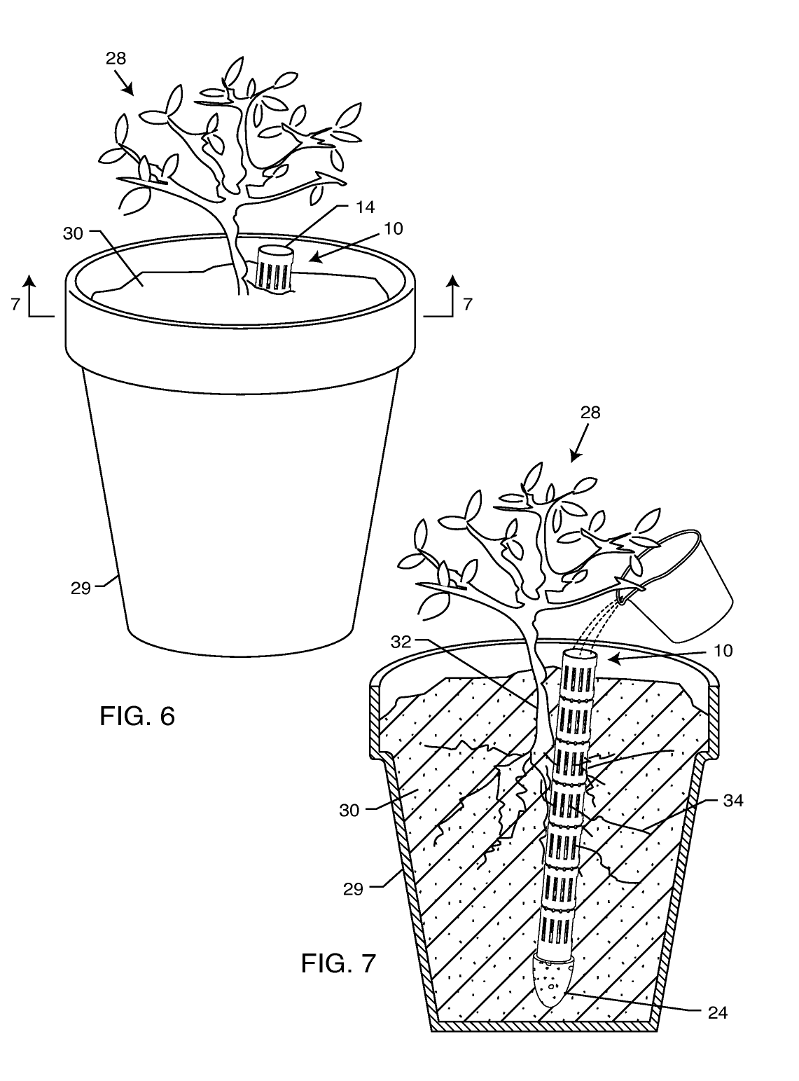

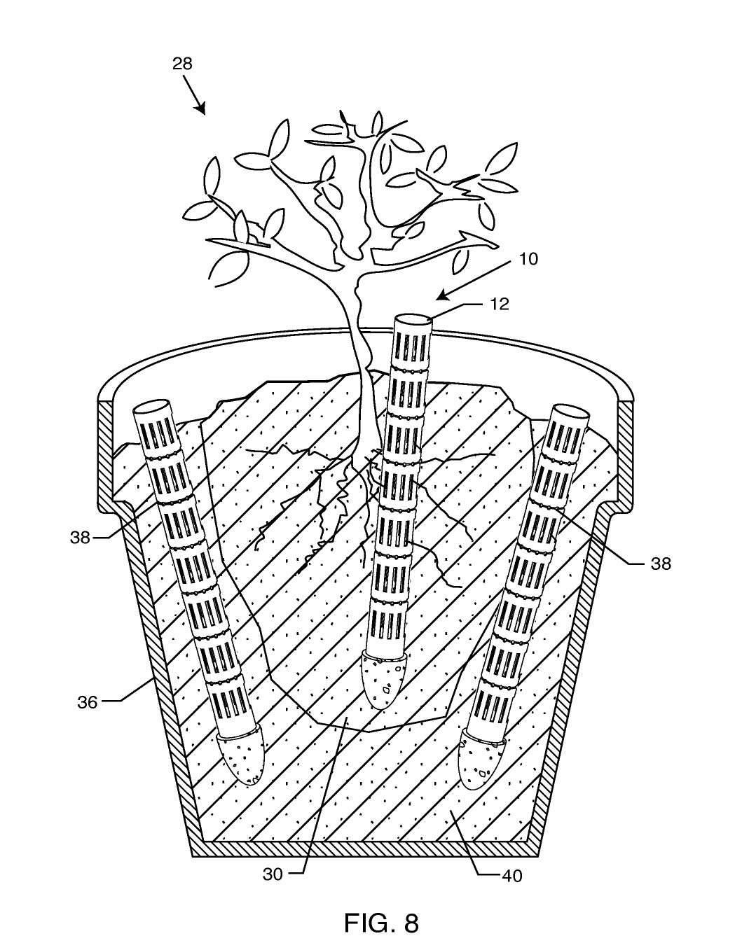

FIGS. 6 and 7 illustrate the use of the apparatus 10 with a potted plant 28. The apparatus 10 is inserted into the soil 30 of the potted plant 28. Preferably, the cylinder 12 is inserted into the soil 30 so that the bottom end 16 is proximate the bottom of the pot 29 and the top end 14 protrudes from the top of the soil 30. The apparatus 10 should be sufficiently close to the stem 32 of the potted plant 28 so that the roots 34 may grow into and through the holes 18 and slots 20, as illustrated in FIGS. 5 and 7 and described below. In addition, the top end 14 should be concealable by branches and/or leaves of the potted plant 28 so as to hide its presence.

After the apparatus 10 has been installed in a potted plant 28, a person tending the plant may pour water and/or fertilizer into the hollow cylinder 12 as illustrated in FIG. 7. The addition of water and/or fertilizer into the cylinder 12 functions to get the nutrients and nourishment directly to the roots of the plant. Without the apparatus 10, fertilizer and/or water would be left to pass down through the soil 30 and allowed to diffuse in every direction. The apparatus brings the water and/or fertilizer directly to the part of the potted plant 28 where it will be most beneficial, i.e., the roots 34.

Over time, soil 30 will pass through the holes 18 and slots 20 in the cylinder 12 and build up a layer of sediment therein. This sediment will act to hold and more slowly release any water and/or fertilizer introduced into the apparatus 10 more slowly. Furthermore, over time, roots 34 which by nature seek out nutrients and moisture, will grow into the cylinder 12 through the holes 18 and slots 20. This growth of the roots 34 into the apparatus 10 provides a means for more direct introduction of water and/or fertilizer to the potted plant 28. In addition, the interior of the cylinder 12 provides a fertile location for the growth of mold and/or algae. Such growth provides a natural fertilizer for the plant and provides pure nitrite to aid in plant growth.

As illustrated in FIG. 8, when a potted plant 28 is transferred into a larger pot, the existing apparatus 10 is left in place and transferred with the potted plant 28 and soil 30 to the new pot 36. Additional cylinders 38 having an identical construction as the cylinder 12 described above may be inserted in the new soil 40 of the new pot 36. In this way, the existing sediment and root growth remain entwined with the old cylinder 12 and additional root growth into the additional cylinders 38 may be achieved. The additional cylinders 38 provide more opportunity to directly introduce fertilizer and/or water to the potted plant 28.

Although several embodiments have been described in detail for purposes of illustration, various modifications may be made without departing from the scope and spirit of the invention. Accordingly, the invention is not to be limited, except as by the appended claims.

What is claimed is:

1. An apparatus for improving vitality of a potted plant, comprising:
an elongated, hollow cylinder for inserting into soil in a potted plant, the cylinder having open top and bottom ends and a plurality of apertures through a side thereof.

2. The apparatus of claim 1, further comprising a plug for closing the bottom end of the cylinder, wherein the plug has a pointed end.

3. The apparatus of claim 2, wherein the plug is comprised of cork, plastic, or an organic material.

4. The apparatus of claim 2, wherein the plug includes a nitrogen plant fertilizer.

5. The apparatus of claim 1, wherein the cylinder includes a plurality of circumferential grooves along its length.

6. The apparatus of claim 1, wherein the cylinder is comprised of terra cotta clay or PVC plastic material.

7. The apparatus of claim 1, wherein the apertures comprise slots or holes.

8. An apparatus for improving vitality of a domestic plant, comprising:
a container having soil in which the plant is potted; and
an elongated, hollow cylinder in the soil, the cylinder having open top and bottom ends and a plurality of apertures through a side thereof.

9. The apparatus of claim 8, wherein the cylinder is comprised of terra cotta clay or PVC plastic material.

10. The apparatus of claim 8, further comprising a plug for closing the bottom end of the cylinder, the plug comprised of cork, plastic, or an organic material.

11. The apparatus of claim 10, wherein the plug includes a nitrogen plant fertilizer.

12. The apparatus of claim 8, wherein the apertures comprise slots or holes.

13. The apparatus of claim 8, wherein the cylinder includes a plurality of circumferential grooves along its length.

14. A method for improving vitality of a domestic plant, comprising the steps of:
planting the domestic plant in a container having soil; and
placing an elongated, hollow cylinder in the soil between the plant and a wall of the container, the cylinder having open top and bottom ends and a plurality of apertures through a side thereof.

15. The method of claim 14, further comprising the step of putting water or fertilizer into the open top end of the cylinder.

16. The method of claim 14, wherein the placing step involves pushing the cylinder down into the soil such that the bottom end is proximate to a bottom of the container and the a portion of the apertures are proximate to roots of the domestic plant such that the roots grow into the apertures.

17. The method of claim 14, further comprising the step of adjusting the length of the cylinder by breaking the cylinder at one of a plurality of circumferential grooves along the length of the cylinder.

18. The method of claim 14, wherein the cylinder includes a plug in the open bottom end and the plug is made from cork, plastic, or an organic composition and includes a nitrogen plant fertilizing compound.

19. The method of claim 14, further comprising the step of transferring the plant from the container to a second container.

20. The method of claim 19, the transferring step comprising the steps of:
removing the plant, soil and cylinder from the container,
repotting the plant, soil and cylinder into the second container using additional soil; and
placing a second elongated, hollow cylinder into the additional soil between the plant and a wall of the second container.
